(19) United States
(12) Patent Application Publication
(10) Pub. No.: US 2024/0424402 A1
(43) Pub. Date: Dec. 26, 2024

(54) METHOD AND APPARATUS FOR CONTROLLING VIRTUAL THROWABLE, DEVICE, MEDIUM, AND PROGRAM PRODUCT

(71) Applicant: Tencent Technology (Shenzhen) Company Limited, Shenzhen (CN)

(72) Inventors: Yizhou LI, Shenzhen (CN); Yiming Sun, Shenzhen (CN)

(21) Appl. No.: 18/824,642

(22) Filed: Sep. 4, 2024

Related U.S. Application Data
(63) Continuation of application No. PCT/CN2023/119991, filed on Sep. 20, 2023.

(30) Foreign Application Priority Data
Dec. 7, 2022 (CN) 202211588401.4

(51) Int. Cl. A63F 13/577; A63F 13/217; G06T 19/00

(52) U.S. Cl. CPC A63F 13/577; A63F 13/217; G06T 19/006

(57) ABSTRACT

This application provides a method for controlling a virtual throwable performed by a computer device. The method includes: displaying a picture of a virtual environment; displaying a virtual fluid substance released by the virtual throwable in response to a thrown virtual throwable exploding in the virtual environment; and in response to the virtual fluid substance encountering a virtual obstacle during diffusion in the virtual environment, changing a direction of the diffusion of the virtual fluid substance based on an interaction of the virtual fluid substance with the virtual obstacle. A scene in which a real virtual fluid substance diffuses in a different direction when encountering the virtual obstacle is simulated by using solutions of embodiments of this application, and a highly realistic diffusion effect of the virtual fluid substance is simulated and highly consistent with cognition in the real world.

### CROSS-REFERENCE TO RELATED APPLICATIONS

This application is a continuation application of PCT Patent Application No. PCT/CN2023/119991, entitled “METHOD AND APPARATUS FOR CONTROLLING VIRTUAL THROWABLE, DEVICE, MEDIUM, AND PROGRAM PRODUCT” filed on Sep. 20, 2023, which claims priority to Chinese Patent Application No. 202211588401.4, entitled “METHOD AND APPARATUS FOR CONTROLLING VIRTUAL THROWABLE, DEVICE, MEDIUM, AND PROGRAM PRODUCT” filed on Dec. 7, 2022, both of which are incorporated herein by reference in their entirety.

### FIELD OF THE TECHNOLOGY

Embodiments of this application relate to the field of human-computer interaction, and in particular, to a method and apparatus for controlling a virtual throwable, a device, a medium, and a program product.

### BACKGROUND OF THE DISCLOSURE

In an application (App) including a virtual environment, a virtual object generally needs to be controlled to perform an activity in the virtual environment, for example, walking, driving a virtual vehicle, climbing, or picking up an item. The virtual object may use a virtual throwable, for example, a virtual smoke grenade. A thrown virtual throwable may trigger the virtual object to obtain a specific skill effect, such as a positive buff and a negative buff.

In the related art, virtual smoke is released by throwing the virtual smoke grenade. When the virtual object is within a range of the virtual smoke, the virtual object is triggered to obtain some skill effects.

However, in the foregoing related art, the virtual smoke can only diffuse within a specific radius, which is inconsistent with actual cognition in the real world and lacks realism.

### SUMMARY

Embodiments of this application provide a method and apparatus for controlling a virtual throwable, a device, a medium, and a program product. The technical solutions are as follows.

According to an aspect of this application, a method for controlling a virtual throwable is performed by a computer device, and the method including:
displaying a picture of a virtual environment;
displaying a virtual fluid substance released by the virtual throwable in response to a thrown virtual throwable exploding in the virtual environment; and
in response to the virtual fluid substance encountering a virtual obstacle during diffusion in the virtual environment, changing a direction of the diffusion of the virtual fluid substance based on an interaction of the virtual fluid substance with the virtual obstacle.

According to another aspect of this application, a computer device is provided, the computer device including: a processor and a memory, the memory having a computer program stored therein, the computer program, when loaded and executed by the processor, causing the computer device to implement the foregoing method for controlling the explosion of a virtual throwable in the virtual environment as described above.

According to another aspect of this application, a non-transitory computer-readable storage medium is provided, having a computer program stored therein, the computer program, when loaded and executed by a processor of a computer device, causing the computer device to implement the method for controlling the explosion of a virtual throwable in the virtual environment as described above.

Beneficial effects brought by the technical solutions provided in the embodiments of this application include at least the following.

According to the method provided in embodiments of this application, the virtual environment picture is displayed. A diffusive virtual fluid substance released by the virtual throwable is displayed in response to a thrown virtual throwable exploding in the virtual environment. The direction of diffusion of the virtual fluid substance is changed based on the virtual obstacle in response to the virtual fluid substance encountering the virtual obstacle during diffusion. By using the method of the embodiments of this application, the direction of diffusion of the virtual fluid substance is changed through the virtual obstacle, and a scene in which a fluid substance diffuses in a different direction when encountering an obstacle in a real world is simulated, so that the virtual fluid substance has a diffusion effect highly consistent with cognition in the real world. To some extent, a game experience of a user may further be improved.

### BRIEF DESCRIPTION OF THE DRAWINGS

FIG. 1 is a structural block diagram showing a computer system according to an exemplary embodiment.

FIG. 2 is a schematic diagram showing a scene of a method for controlling a virtual throwable according to an exemplary embodiment.

FIG. 3 is a schematic diagram showing a scene of a method for controlling a virtual throwable according to an exemplary embodiment.

FIG. 4 is a flowchart showing a method for controlling a virtual throwable according to an exemplary embodiment.

FIG. 5 is a flowchart showing a method for controlling a virtual throwable according to an exemplary embodiment.

FIG. 6 is a schematic diagram showing traversal of a special effect cell according to an exemplary embodiment.

FIG. 7 is a flowchart showing a method for controlling a virtual throwable according to an exemplary embodiment.

FIG. 8 is a flowchart showing a method for controlling a virtual throwable according to an exemplary embodiment.

FIG. 9 is a flowchart showing a method for controlling a virtual throwable according to an exemplary embodiment.

FIG. 10 is a schematic diagram of determining whether a position of a virtual object is within an action range according to an exemplary embodiment.

FIG. 11 is a flowchart showing a method for controlling a virtual throwable according to an exemplary embodiment.

FIG. 12 is a schematic diagram of determining a shortest reachable path between a position of a virtual object and an action center according to an exemplary embodiment.

FIG. 13 is a schematic diagram of determining a shortest reachable path between a position of a virtual object and an action center according to an exemplary embodiment.

FIG. 14 is a flowchart showing a method for controlling a virtual throwable according to an exemplary embodiment.

FIG. 15 is a flowchart showing a method for controlling a virtual throwable according to an exemplary embodiment.

FIG. 16 is a structural block diagram of an apparatus for controlling a virtual throwable according to an exemplary embodiment.

FIG. 17 is a structural block diagram of a computer device according to an exemplary embodiment.

### DESCRIPTION OF EMBODIMENTS

First, terms involved in embodiments of this application are briefly described.

Virtual environment: It is a virtual environment displayed (or provided) when an application (App) runs on a terminal. The virtual environment may be a simulated world of the real world, or may be a semi-simulation and semi-fiction three-dimensional world, and may further be a purely fictional three-dimensional world. The virtual environment may be any one of a two-dimensional virtual environment, a 2.5-dimensional virtual environment, and a three-dimensional virtual environment. In some embodiments, the virtual environment is further configured for a virtual environment battle between at least two virtual objects, and there are virtual resources available for use by the at least two virtual objects in the virtual environment. In some embodiments, the virtual environment includes a lower left area and an upper right area that are symmetrical, and virtual objects belonging to two hostile camps respectively occupy one of the areas.

Virtual object (or referred to as virtual character): It refers to a movable object in a virtual environment. The movable object may be at least one of a virtual character, a virtual animal, and a cartoon character. In some embodiments, when the virtual environment is the three-dimensional virtual environment, the virtual object may be a three-dimensional virtual model. Each virtual object has a shape and a volume in the virtual environment, and occupies a part of space in the virtual environment. In some embodiments, the virtual object is a three-dimensional character constructed based on a three-dimensional human skeleton technology. The virtual object implements a different external image by wearing a different skin. In some implementations, the virtual object may also be implemented by using a 2.5-dimensional model or 2-dimensional model, which is not limited in the embodiments of this application.

In response to: The expression “in response to” is used for indicating a condition or a status on which one or more to-be-performed operations depend. When the condition or the status on which the to-be-performed operation depends is met, the one or more operations may be performed in real time or with a set delay. Unless otherwise specified, a sequence in which a plurality of operations are performed is not limited.

Virtual throwable: It is a virtual item that may be thrown and used by a virtual object in a virtual environment, for example, at least one of a virtual smoke grenade, a virtual bomb, a virtual frangible grenade, and a virtual gas bottle.

Virtual fluid substance: It is a virtual substance with a fluid property released by a virtual throwable, including but not limited to a virtual liquid, a virtual gas, and virtual smoke. An example in which the virtual throwable is the virtual smoke grenade is used. The virtual fluid substance is virtual smoke released by the virtual smoke grenade.

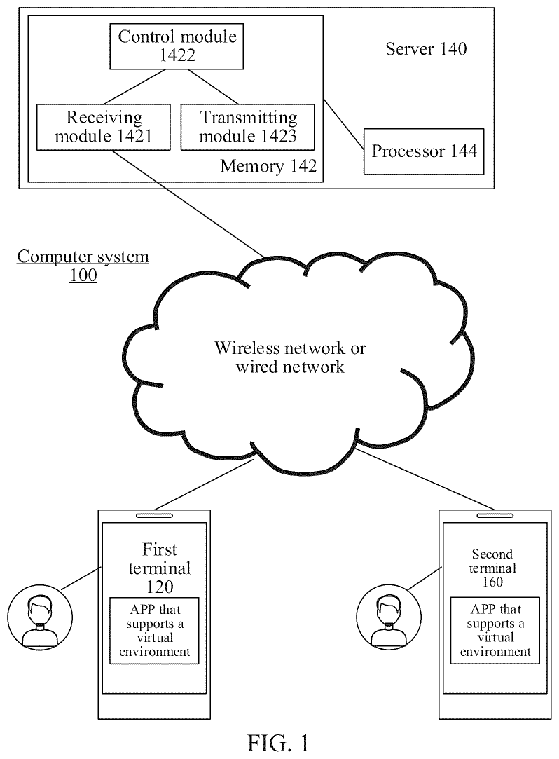

FIG. 1 is a structural block diagram of a computer system according to an exemplary embodiment of this application. The computer system may be referred to as a system architecture for implementing a method for controlling a virtual throwable. The computer system 100 includes a first terminal 120, a server 140, and a second terminal 160.

An App supporting a virtual environment is installed and run on the first terminal 120. In some embodiments, the App may further provide an automatic pathfinding function. Exemplarily, the App may be any one of a battle royale shooting game, a virtual reality (VR) App, an augmented reality (AR) program, a three-dimensional map program, a VR game, an AR game, a first-person shooting game (FPS), a third-person shooting game (TPS), a multiplayer online battle arena (MOBA) game, and a simulation game (SLG).

The first terminal 120 is a terminal used by a first user. The first user uses the first terminal 120 to control a first virtual object located in the virtual environment. The controlling includes but is not limited to at least one of adjusting a body posture, crawling, walking, running, riding, jumping, driving, pickup, shooting, attacking, throwing, and constructing a virtual building. The first user may further use the first terminal 120 to throw the virtual throwable in the virtual environment. The first terminal 120 controls a diffusion process of the virtual fluid substance generated through an explosion of the virtual throwable based on at least one of an attribute and a skill of the virtual throwable, and a distribution of a virtual obstacle in the virtual environment.

The first terminal 120 is connected to the server 140 through a wireless network or a wired network.

The server 140 may be an independent physical server, or may be a server cluster formed by a plurality of physical servers or a distributed system, and may further be a cloud server providing basic cloud computing services such as a cloud server providing a cloud computing service, a cloud database, cloud computing, a cloud function, cloud storage, a network service, cloud communication, a middleware service, a domain name service, a security service, a content delivery network (CDN), a big data and artificial intelligence (AI) platform. The server 140 includes at least one of one server, a plurality of servers, a cloud computing platform, and a virtualization center.

Exemplarily, the server 140 includes a processor 144 and a memory 142. The memory 142 further includes a receiving module 1421, a control module 1422, and a transmitting module 1423. The receiving module 1421 is configured to receive a request transmitted by a client, for example, a request to view at least one of a quantity, positions, and attributes of enemy virtual objects. The control module 1422 is configured to control rendering of a virtual environment picture. The transmitting module 1423 is configured to transmit a response to a client, such as transmitting at least one of the quantity, the positions, and the attribute points of the enemy virtual objects to the client. The server 140 is configured to provide a background service for the Apps on the first terminal 120 and the second terminal 160.

In some embodiments, the server 140 is in charge of primary computing, and the first terminal 120 and the second terminal 160 are in charge of secondary computing. Alternatively, the server 140 is in charge of secondary computing, and the first terminal 120 and the second terminal 160 are in charge of primary computing. Alternatively, the server 140, the first terminal 120, and the second terminal 160 perform collaborative computing by using a distributed computing architecture.

An App supporting a virtual environment is installed and run on the second terminal 160. In some embodiments, the App may further provide an automatic pathfinding function. The App may be any one of a battle royale shooting game, a virtual reality (VR) App, an augmented reality (AR) program, a three-dimensional map program, a VR game, an AR game, a first-person shooting game (FPS), a third-person shooting game (TPS), a multiplayer online battle arena (MOBA), and a simulation game (SLG).

The second terminal 160 is a terminal used by a second user. The second user uses the second terminal 160 to control a second virtual object located in the virtual environment. The controlling includes but is not limited to at least one of adjusting a body posture, crawling, walking, running, riding, jumping, driving, pickup, shooting, attacking, throwing, and constructing a virtual building. When the first user uses the first terminal 120 to throw the virtual throwable in the virtual environment, the second terminal automatically controls, based on an action range of the virtual fluid substance released by the virtual throwable, the action range being less than or equal to a diffusion range, and a position of the second virtual object, whether to trigger the virtual object to obtain a buff of the virtual fluid substance. The buff includes at least one of a positive buff and a negative buff. The positive buff may be increasing a health point, a skill point, and an attribute point of the virtual object, or triggering the virtual object to hide in at least one of positions. The negative buff may be reducing the health point, the skill point, and the attribute point of the virtual object, or triggering the virtual object to expose the at least one position thereof.

In some embodiments, the virtual object controlled by the first user through the first terminal 120 and the virtual object controlled by the second user through the second terminal 160 are located in different positions in the same virtual environment. To be specific, the first user and the second user are in the same battle.

In some embodiments, the App installed on the first terminal 120 is same as the App installed on the second terminal 160, or the Apps installed on the two terminals are the same type of applications on different control system platforms. In the embodiments of this application, a form of the App installed on the first terminal 120 and the App installed on the second terminal 160 is not limited, including but not limited to the App and an applet installed on the first terminal 120 and the second terminal 160, and may further be a form of a website. The first terminal 120 may generally refer to one of a plurality of terminals, and the second terminal 160 may generally refer to one of a plurality of terminals. In this embodiment, only the first terminal 120 and the second terminal 160 are used as an example for description. The first terminal 120 and the second terminal 160 are of the same device type or different device types. The device type includes: at least one of a smartphone, a tablet computer, a wearable device, a personal computer (PC), an e-book reader, a digital player, a portable laptop computer, and a desktop computer. In the following embodiment, an example in which a terminal includes a smartphone is used for description.

A person skilled in the art may understand that more or fewer terminals may be provided. For example, only one terminal (namely, a user and AI play a battle) may be provided, or 8 terminals (1v1v1v1v1v1v1v1, a round robin and an elimination match are performed among 8 users, and a winner is finally determined) may be provided, or a larger quantity of terminals are provided. A quantity of terminals and the terminal type are not limited in this embodiment of this application.

An embodiment of this application provides a method for controlling a virtual throwable. The method is performed by a computer device. In some embodiments, the computer device includes the first terminal 120 or the second terminal 160 shown in FIG. 1. An App supporting a virtual environment is installed and run on the first terminal 120 and the second terminal 160. In some embodiments, the App may further provide an automatic pathfinding function.

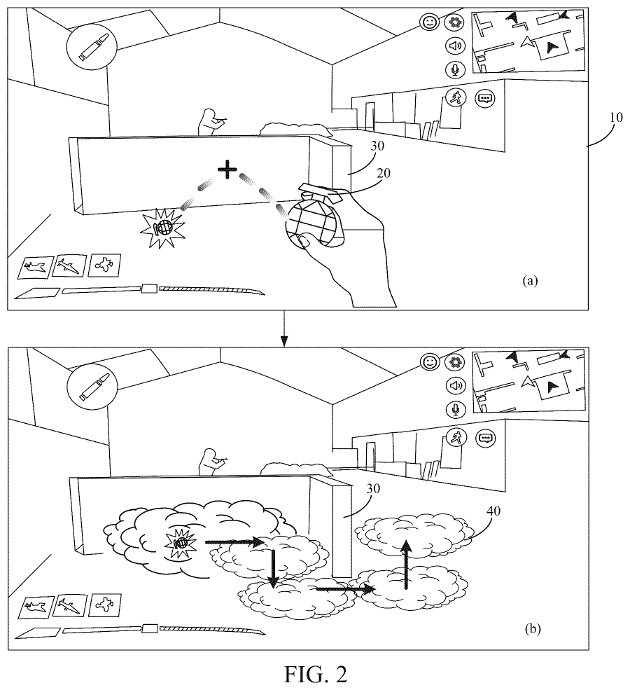

FIG. 2 is a schematic diagram showing a scene of a method for controlling a virtual throwable according to an exemplary embodiment of this application. As shown in (a) in FIG. 2, a virtual environment picture 10 is displayed on a user interface (UI). A computer device is configured to: display a diffusive virtual fluid substance 40 released by a virtual throwable 20 in response to the thrown virtual throwable 20 exploding in a virtual environment; and change, in response to the virtual fluid substance 40 encountering a virtual obstacle 30 during diffusion, a direction of diffusion of the virtual fluid substance 40 based on the virtual obstacle 30.

The virtual environment picture is a picture obtained by capturing a picture of a virtual environment.

In some embodiments, the virtual throwable 20 includes at least one of a virtual smoke grenade, a virtual frangible grenade, and a virtual gas bottle, but is not limited thereto, which is not limited in this embodiment of this application.

Exemplarily, a method for throwing the virtual throwable 20 includes at least one of a high throw, a low throw, and a rebound from impact of the virtual throwable 20, which is not limited in this application. To be specific, the virtual throwable 20 may be thrown through at least one of the high throw, the low throw, and the rebound from impact.

In some embodiments, throwing the virtual throwable 20 through the high throw means throwing the virtual throwable 20 upward. To be specific, an initial throwing direction of the virtual throwable 20 is upward. Throwing the virtual throwable 20 through the low throw means throwing the virtual throwable 20 downward. To be specific, an initial throwing direction of the virtual throwable 20 is downward. Throwing the virtual throwable 20 through the rebound from impact means throwing the virtual throwable 20 toward the virtual obstacle 30. To be specific, the initial throwing direction of the virtual throwable 20 is toward the virtual throwable 20, and the virtual throwable 20 rebounds and reverses after hitting the virtual obstacle 30.

The virtual fluid substance 40 refers to a virtual substance with a fluid property released by the virtual throwable 20. The virtual smoke grenade is used as an example. The virtual fluid substance 40 is virtual smoke released by the virtual smoke grenade.

Exemplarily, as shown in (b) in FIG. 2, a computer device changes a direction of diffusion of the virtual fluid substance 40 based on the virtual obstacle 30 in response to the virtual fluid substance 40 encountering the virtual obstacle 30 during diffusion, so that the virtual fluid substance 40 diffuses along a surface of the virtual obstacle 30.

In some embodiments, the computer device sets a special effect cell within a first range with an explosion point of the virtual throwable 20 as a center. The special effect cell is configured to determine the direction of diffusion of the virtual fluid substance 40. The first range is greater than a second range. The second range is configured to indicate a diffusion range of the virtual fluid substance 40.

The computer device traverses the special effect cell within the first range, and determines the special effect cell within the first range that meets a valid diffusion condition as a valid special effect cell. The computer device determines the direction of diffusion of the virtual fluid substance 40 based on the valid special effect cell.

The valid diffusion condition includes that the special effect cell is within the second range, the special effect cell does not overlap with the virtual obstacle 30, and the special effect cell is not traversed.

Exemplarily, the computer device uses, as a starting special effect cell, the special effect cell in which the explosion point is located. The computer device traverses the special effect cell adjacent to the starting special effect cell, and determines, as a next starting special effect cell, the special effect cell adjacent to the starting special effect cell and meeting the valid diffusion condition. The previous operation is repeatedly performed until the valid special effect cells within the first range are all traversed.

In some embodiments, when the special effect cell where the explosion point is located is the valid special effect cell, the special effect cell where the explosion point is located is used as the starting special effect cell.

In some embodiments, when the special effect cell where the explosion point is located is not the valid special effect cell, the special effect cell within the first range that meets a radiation detection condition is determined as the starting special effect cell.

The radiation detection condition includes that a to-be-detected special effect cell and the special effect cell where the explosion point is located can be connected through a ray, and the to-be-detected special effect cell does not overlap with the virtual obstacle.

Based on the above, according to the method provided in the embodiments of this application, the virtual environment picture is displayed. A diffusive virtual fluid substance released by the virtual throwable is displayed in response to a thrown virtual throwable exploding in the virtual environment. The direction of diffusion of the virtual fluid substance is changed based on the virtual obstacle in response to the virtual fluid substance encountering the virtual obstacle during diffusion. By using the method of the embodiments of this application, the direction of diffusion of the virtual fluid substance is changed through the virtual obstacle, and a scene in which a fluid substance diffuses in a different direction when encountering an obstacle in a real world is simulated, so that the virtual fluid substance has a diffusion effect highly consistent with cognition in the real world. To some extent, a game experience of a user may further be improved.

In some embodiments, the virtual fluid substance 40 has specific impact on the virtual object that enters the action range thereof, for example, at least one of reducing a health point, a skill point, and an attribute point of the virtual object, and exposing at least one of the positions of the virtual object, or at least one of increasing the health point, the skill point, and the attribute point of the virtual object, and hiding at least one of the positions of the virtual object. In some embodiments, the action range of the virtual fluid substance 40 is greater than or equal to the diffusion range.

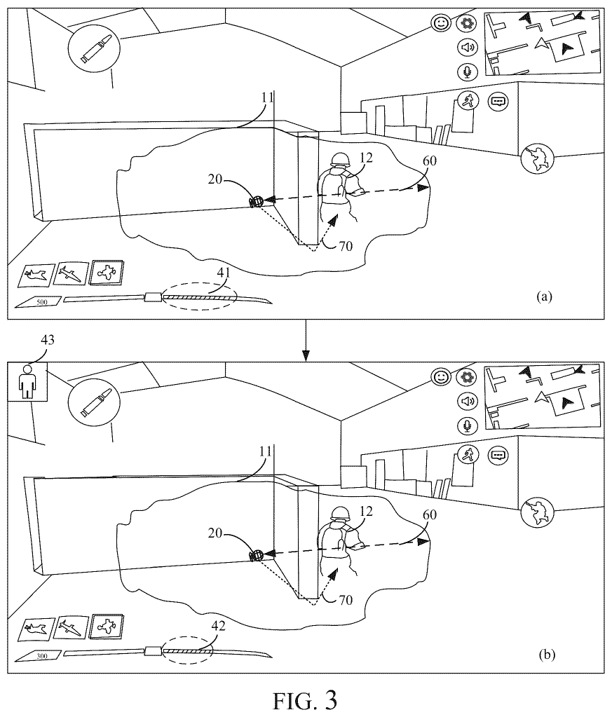

FIG. 3 is a schematic diagram showing a scene of a method for controlling a virtual throwable according to an exemplary embodiment of this application. As shown in (a) in FIG. 3, an explosion point of a virtual throwable 20 is regarded as an action center corresponding to an action range 11 of a virtual fluid substance. An action distance corresponding to the action range 11 is a maximum diffusion distance 60 of the virtual fluid substance, and the maximum diffusion distance 60 is also referred to as an action radius of the action range 11.

A computer device determines, based on a position of a virtual object 12 and a position of the action center, a straight-line distance between the virtual object 12 and the action center between the two positions in response to the virtual object 12 entering the action range 11 of the virtual fluid substance. When the straight-line distance is less than the action distance, it is determined that the position of the virtual object 12 is within the action range of the virtual fluid substance. A shortest reachable path between the action center and the position of the virtual object 12 is a shortest path 70 for the virtual fluid substance to diffuse to the position of the virtual object 12 along a surface of the virtual obstacle 30. When the shortest reachable path 70 is less than the action distance, the virtual object is triggered to obtain a buff of the virtual fluid substance.

Exemplarily, an example in which the buff is a negative buff is used. A health point 41 of the virtual object shown in (a) of FIG. 3 is reduced to a health point 42 shown in (b) of FIG. 3. The health point 42 is less than the health point 41. In some embodiments, a current physical condition of the virtual object is further displayed in a display area 43 of the UI. For example, a prompt that “a severe lung injury: a chest continuously loses health, a movement speed is greatly reduced, and an upper limit of physical strength is greatly reduced” is shown.

Based on the above, the method provided in the embodiments of this application further includes determining whether the virtual object exists within the action range of the virtual fluid substance, and further includes determining whether the virtual object within the action range of the virtual fluid substance triggers to obtain the buff, which not only considers whether the virtual object is within the action range of the virtual fluid substance, and but also considers the impact of the virtual obstacle on the diffusion of the virtual fluid substance, so that a determination as to whether one or more virtual objects obtain the buff is highly consistent with cognition and has a highly realistic effect. To some extent, a game experience of a user may further be improved.

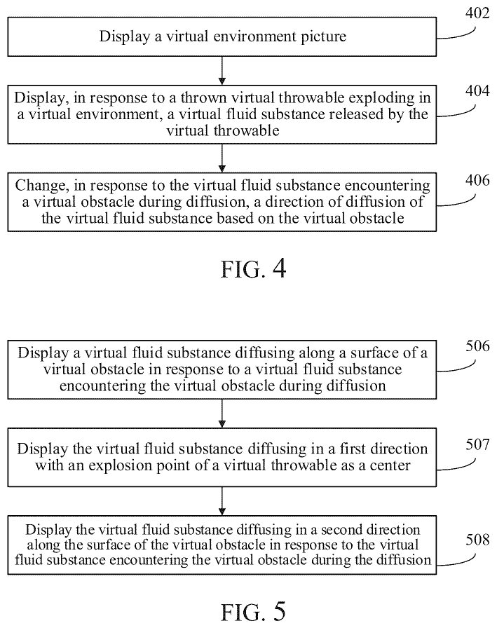

FIG. 4 is a flowchart showing a method for controlling a virtual throwable according to an exemplary embodiment of this application. An example in which the method is applied to a first terminal 120 or an App installed on the first terminal 120 or a second terminal 160 or an App installed on the second terminal 160 shown in FIG. 1 is used for description. The method may include the following operations.

Operation 402: Display a virtual environment picture.

A virtual environment is a three-dimensional virtual activity space provided by an App in a terminal during operation, for the virtual object to perform various activities in the three-dimensional virtual activity space.

The virtual object is a movable object controlled by a user through a terminal. The terminal controls, based on a received user operation, the virtual object to move in the virtual environment, for example, walking, running, jumping, climbing, getting down, attacking, releasing a skill, picking up a prop, or sending a message, which is not limited in this embodiment.

Exemplarily, the position of the virtual object in the virtual environment may be equivalent to a central position in a map display control, or may be another position in the map display control. To be specific, the position of the virtual object in the virtual environment may correspond to a center of the map display control, or may correspond to another position of the map display control.

Exemplarily, the virtual environment picture is a two-dimensional picture displayed on the terminal obtained by capturing a picture of a three-dimensional virtual environment. Exemplarily, a shape of the virtual environment picture is determined based on a shape of a display screen of the terminal, or based on a shape of a UI of the terminal. An example in which the display screen of the terminal is rectangular is used, and the virtual environment picture is also displayed as a rectangular picture.

Operation 404: Display a virtual fluid substance released by a virtual throwable in response to a thrown virtual throwable exploding in a virtual environment.

The virtual throwable refers to a virtual item that can be thrown by a virtual character in the virtual environment.

Operation 406: Change, in response to the virtual fluid substance encountering a virtual obstacle during diffusion, a direction of diffusion of the virtual fluid substance based on the virtual obstacle.

Exemplarily, a computer device changes the direction of diffusion of the virtual fluid substance based on the virtual obstacle in response to the virtual fluid substance encountering the virtual obstacle during diffusion.

A virtual smoke grenade is used as an example. After the virtual smoke grenade releases virtual smoke, the virtual smoke diffuses around. When the virtual smoke hits a wall during the diffusion, the wall changes the direction of diffusion of the virtual smoke, and the virtual smoke diffuses along a direction of the wall.

Based on the above, according to the method provided in this embodiment, the virtual environment picture is displayed. A diffusive virtual fluid substance released by the virtual throwable is displayed in response to a thrown virtual throwable exploding in the virtual environment. The direction of diffusion of the virtual fluid substance is changed based on the virtual obstacle in response to the virtual fluid substance encountering the virtual obstacle during diffusion. In this application, a scene in which a real virtual fluid substance diffuses in a different direction when encountering an obstacle is simulated by changing the direction of diffusion of the virtual fluid substance through the virtual obstacle, so as to simulate a highly realistic diffusion effect of the virtual fluid substance in the foregoing manner, thereby enhancing user experience.

FIG. 5 is a flowchart showing a method for controlling a virtual throwable according to an exemplary embodiment of this application. An example in which the method is applied to a first terminal 120 or an App installed on the first terminal 120 or a second terminal 160 or an App installed on the second terminal 160 shown in FIG. 1 is used for description. In some embodiments, operation 406 described above may be implemented as the following operations.

Operation 506: Display the virtual fluid substance diffusing along a surface of the virtual obstacle in response to the virtual fluid substance encountering the virtual obstacle during the diffusion.

Exemplarily, a computer device changes the direction of diffusion of the virtual fluid substance based on the virtual obstacle in response to the virtual fluid substance encountering the virtual obstacle during diffusion.

A virtual smoke grenade is used as an example. After the virtual smoke grenade releases virtual smoke, the virtual smoke diffuses around. When the virtual smoke hits a wall during the diffusion, the wall changes the direction of diffusion of the virtual smoke, and the virtual smoke diffuses along a direction of the wall.

In some embodiments, operation 506 described above may be implemented as the following operations.

Operation 507: Display the virtual fluid substance diffusing in a first direction with an explosion point of the virtual throwable as a center.

Exemplarily, the virtual fluid substance diffuses in the first direction with the explosion point of the virtual throwable as the center during the diffusion, the first direction including any direction of 360 degrees around the explosion point.

Exemplarily, the computer device displays the virtual fluid substance diffusing in the first direction with the explosion point of the virtual throwable as the center.

Operation 508: Display the virtual fluid substance diffusing in a second direction along a surface of the virtual obstacle in response to the virtual fluid substance encountering the virtual obstacle during diffusion.

Exemplarily, when the virtual fluid substance encounters the virtual obstacle during diffusion, the direction of diffusion is changed, and the virtual fluid substance diffuses in the second direction along the surface of the virtual obstacle. In some embodiments, the second direction refers to a direction different from the first direction. In other words, the virtual fluid substances do not overlap during the diffusion.

Exemplarily, the computer device displays the virtual fluid substance diffusing in the second direction along the surface of the virtual obstacle in response to the virtual fluid substance encountering the virtual obstacle during the diffusion.

In this embodiment, the computer device displays the virtual fluid substance diffusing along the surface of the virtual obstacle, so that the virtual fluid substance has a diffusion effect highly consistent with cognition in the real world, and the user may visually observe the diffusion process, thereby enhancing user experience.

In some embodiments, the virtual fluid substance diffuses along the surface of the virtual obstacle in operation 506 described above. The diffusion process may be implemented as follows.

The computer device sets a special effect cell within a first range with an explosion point of the virtual throwable as a center. The special effect cell is configured to determine the direction of diffusion of the virtual fluid substance. The first range is greater than a second range. The second range is configured to indicate a diffusion range of the virtual fluid substance.

The computer device traverses the special effect cell within the first range, and determines the special effect cell within the first range that meets a valid diffusion condition as a valid special effect cell. When the virtual fluid substance encounters the virtual obstacle during the diffusion, the virtual fluid substance diffuses based on the valid special effect cell on the surface of the virtual obstacle.

The valid diffusion condition includes that the special effect cell is within the second range, the special effect cell does not overlap with the virtual obstacle, and the special effect cell is not traversed.

In some embodiments, the computer device uses, as a starting special effect cell, the special effect cell in which the explosion point is located.

The computer device traverses the special effect cell adjacent to the starting special effect cell, and determines, as a next starting special effect cell, the special effect cell adjacent to the starting special effect cell and meeting the valid diffusion condition.

The previous operation is repeatedly performed until the valid special effect cells within the first range are all traversed.

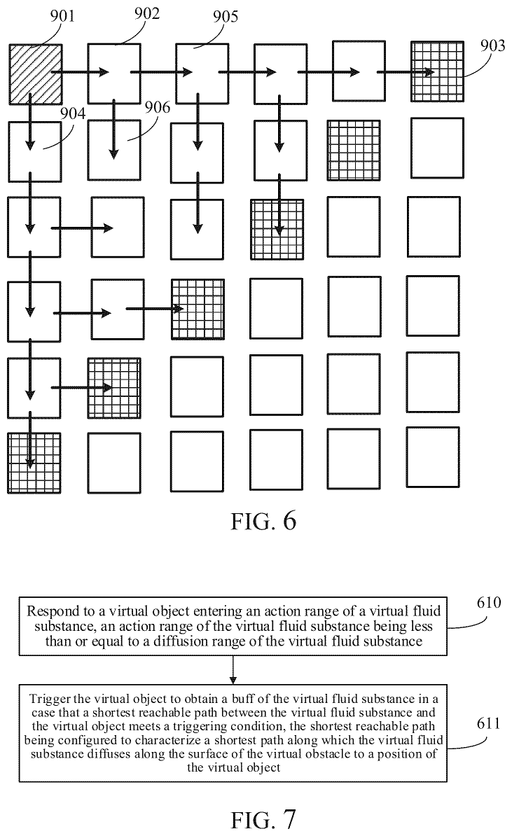

Exemplarily, FIG. 6 is a schematic diagram of traversing a special effect cell. A 6*6 two-dimensional effect grid is used as an example. A first special effect cell in an upper left corner of FIG. 9 is used as a starting special effect cell 901, and the starting special effect cell 901 is used as a starting point to traverse a special effect cell adjacent to the starting special effect cell 901. Specifically, a special effect cell 902 adjacent to the starting special effect cell 901 in a horizontal direction is traversed, and a special effect cell 904 adjacent to the starting special effect cell 901 in a vertical direction is traversed. Assuming that the special effect cell 902 meets the valid diffusion condition, the special effect cell 902 that meets the valid diffusion condition in the special effect cell adjacent to the starting special effect cell 901 is determined as a valid special effect cell, and the determined valid special effect cell 902 adjacent to the starting special effect cell 901 is also used as a new starting special effect cell. The special effect cell adjacent to the new starting special effect cell 902 continues to be traversed. Specifically, a special effect cell 905 adjacent to the new starting special effect cell 902 in the horizontal direction (the special effect cell 901 adjacent to the new starting special effect cell 902 has been traversed, and does not need to be traversed again) is traversed, and a special effect cell 906 adjacent to the new starting special effect cell 902 in the vertical direction is traversed. The foregoing operations are repeated until the traversal ends when there is no new valid special effect cell. Alternatively, the traversal ends until the traversal reaches an edge special effect cell 903, or the traversal ends until all of the special effect cells have been traversed.

In a possible implementation, when the special effect cell where the explosion point is located is the valid special effect cell, the special effect cell where the explosion point is located is used as the starting special effect cell.

The starting special effect cell refers to a special effect cell that is used as a starting point to traverse another special effect cell.

In a possible implementation, when the special effect cell where the explosion point is located is not the valid special effect cell, the special effect cell within the first range that meets a radiation detection condition is determined as the starting special effect cell.

The radiation detection condition includes that a to-be-detected special effect cell and the special effect cell where the explosion point is located can be connected through a ray, and the to-be-detected special effect cell does not overlap with the virtual obstacle.

In this embodiment, the special effect cell is set within the first range with the explosion point of the virtual throwable as the center. The special effect cell within the first range that meets the valid diffusion condition is determined as the valid special effect cell by traversing the special effect cell within the first range. When the virtual fluid substance encounters the virtual obstacle during diffusion, the diffusion is performed based on the valid special effect cell on the surface of the virtual obstacle. Validity of traversing the special effect cell is implemented by calculating a distance between the special effect cells, so as to determine the direction of diffusion of the virtual fluid substance, thereby reducing an amount of calculation, reducing a requirement for a hardware device, and improving efficiency.

FIG. 7 is a flowchart showing a method for controlling a virtual throwable according to an exemplary embodiment of this application. An example in which the method is applied to a first terminal 120 or an App installed on the first terminal 120 or a second terminal 160 or an App installed on the second terminal 160 shown in FIG. 1 is used for description. The method may further include the following operations.

Operation 610: Respond to a virtual object entering an action range of the virtual fluid substance, the action range of the virtual fluid substance being less than or equal to a diffusion range of the virtual fluid substance.

The action range of the virtual fluid substance refers to a range that can produce a buff on the virtual object. In some embodiments, the action range of the virtual fluid substance is less than or equal to the diffusion range of the virtual fluid substance.

Exemplarily, the diffusion range of the virtual fluid substance is preset, and may be determined based on an attribute point and a level value of the virtual throwable or based on at least one of components of the virtual fluid substance. If the virtual fluid substance has a higher level and a stronger attribute, or a particle of the component is lighter and smaller, a corresponding diffusion range is larger.

Exemplarily, the action range of the virtual fluid substance is less than the diffusion range of the virtual fluid substance, which may mean that the virtual throwable explodes within a four-sided enclosed cover. A range corresponding to the cover is less than the diffusion range of the virtual fluid substance. In this case, the diffusion range of the virtual fluid substance is equal to the range of the four-sided enclosed cover.

Operation 611: Trigger the virtual object to obtain a buff of the virtual fluid substance when a shortest reachable path between the virtual fluid substance and the virtual object meets a triggering condition, the shortest reachable path being configured to characterize a shortest path along which the virtual fluid substance diffuses along the surface of the virtual obstacle to a position of the virtual object.

The shortest reachable path refers to a shortest path along which the virtual fluid substance diffuses along the surface of the virtual obstacle in the virtual environment to the position of the virtual object.

The triggering condition refers to a condition that needs to be met to trigger the virtual object to obtain the buff. The buff includes one of a positive buff (buff) and a negative buff (debuff).

Exemplarily, the virtual object is triggered to obtain the buff of the virtual fluid substance when the shortest reachable path between the virtual fluid substance and the virtual object meets the triggering condition,

Based on the above, in the method provided in the embodiments of this application, not only whether the virtual object is within the action range of the virtual fluid substance, and but also the impact of the virtual obstacle on the diffusion of the virtual fluid substance in the virtual environment are taken into account, so that a determination as to whether one or more virtual objects obtain the buff is more cognitive and has a highly realistic effect. To some extent, a game experience of a user may further be improved.

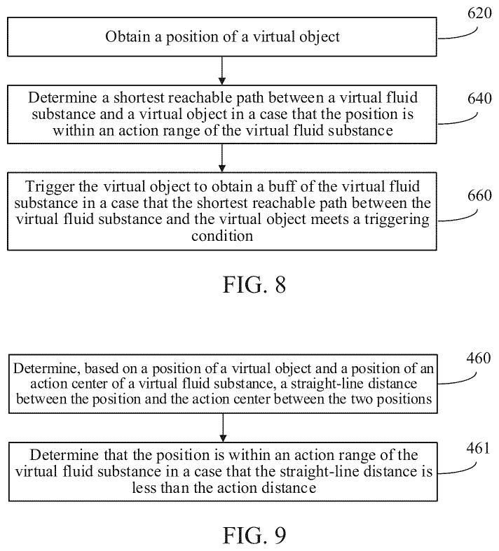

In some embodiments, FIG. 8 is a flowchart showing a method for controlling a virtual throwable according to an exemplary embodiment of this application. An example in which the method is applied to a first terminal 120 or an App installed on the first terminal 120 or a second terminal 160 or an App installed on the second terminal 160 shown in FIG. 1 is used for description. The method may further include the following operations.

Operation 620: Obtain a position of a virtual object.

The position of the virtual object is a position of the virtual object at a current moment.

Exemplarily, the position of the virtual object is represented by a three-dimensional coordinate point. One or more virtual objects are included.

Operation 640: Determine a shortest reachable path between a virtual fluid substance and the virtual object when the position is within an action range of the virtual fluid substance.

The shortest reachable path refers to a shortest path along which the virtual fluid substance diffuses along the surface of the virtual obstacle in the virtual environment to the position of the virtual object.

In some embodiments, the App installed on the terminal provides an automatic pathfinding function. The automatic pathfinding function is a self-installed function of an App engine, which is configured for indexing the virtual environment and automatically finding one or more shortest paths from a preset starting point to a preset end point without being blocked by the virtual obstacle in the virtual environment.

In this embodiment, the preset starting point is a preset point within the action range of the virtual fluid substance, and the preset end point includes a position point of the virtual object. In some embodiments, the preset starting point may be any point within the action range of the virtual fluid substance, including a center point of the action range of the virtual fluid substance, which is referred to as an action center. The action center is also an explosion point of the virtual throwable.

In some embodiments, a computer device enables the automatic pathfinding function in response to an enabling operation of the automatic pathfinding function. When the position of the virtual object is within the action range of the virtual fluid substance, the shortest reachable path between the virtual fluid substance and the virtual object is determined through the automatic pathfinding function.

Operation 660: Trigger the virtual object to obtain a buff of the virtual fluid substance when a shortest reachable path between the virtual fluid substance and the virtual object meets a triggering condition.

In some embodiments, the triggering condition includes that the shortest reachable path is less than the action distance corresponding to the action range. In some embodiments, the action distance includes a maximum diffusion distance of the action range, which may be an action radius of the action range. When the action range is irregular, the action distance may be half of a long axis of the action range.

Exemplarily, when the action range of the virtual fluid substance is the diffusion range, and the diffusion range is preset, the action distance corresponding to the action range is preset. When the action range of the virtual fluid substance is less than the diffusion range, the action distance corresponding to the action range is determined based on the long axis of an actual action range.

Exemplarily, when the shortest reachable path meets the triggering condition, the virtual object is triggered to obtain the buff of the virtual fluid substance.

In this embodiment, not only whether the virtual object is within the action range of the virtual fluid substance, and but also the impact of the virtual obstacle on the diffusion of the virtual fluid substance in the virtual environment are taken into account, so that a determination as to whether one or more virtual objects obtain the buff is more cognitive and has a highly realistic effect. To some extent, a game experience of a user may further be improved.

In some embodiments, whether the virtual object is located within the action range of the virtual fluid substance needs to be determined first. FIG. 9 is a flowchart of a method for controlling a virtual throwable according to an exemplary embodiment of this application. The method may include the following operations.

Operation 460: Determine, based on the position of the virtual object and the position of the action center of the virtual fluid substance, a straight-line distance between the position and the action center between the two positions.

Exemplarily, the action center of the virtual fluid substance is a center of the action range of the virtual fluid substance, namely, an explosion point of the virtual throwable.

In some embodiments, the straight-line distance between the position of the virtual object and the action center is determined based on three-dimensional coordinates of the position of the virtual object and three-dimensional coordinates of the action center of the virtual fluid substance.

In some embodiments, a ray is emitted from the action center of the virtual fluid substance to the position of the virtual object, a line segment between the action center and the position is determined, and a straight-line distance between the position and the action center is determined based on a line segment length of the line segment. The foregoing process of emitting the ray ignores a virtual obstacle between the action center and the position.

Operation 461: Determine that the position is within the action range of the virtual fluid substance when the straight-line distance is less than the action distance.

Exemplarily, the action distance is a maximum diffusion distance corresponding to the action range of the virtual fluid substance, which is also referred to as an action radius. It is determined that the position is within the action range of the virtual fluid substance when the straight-line distance is less than the action distance.

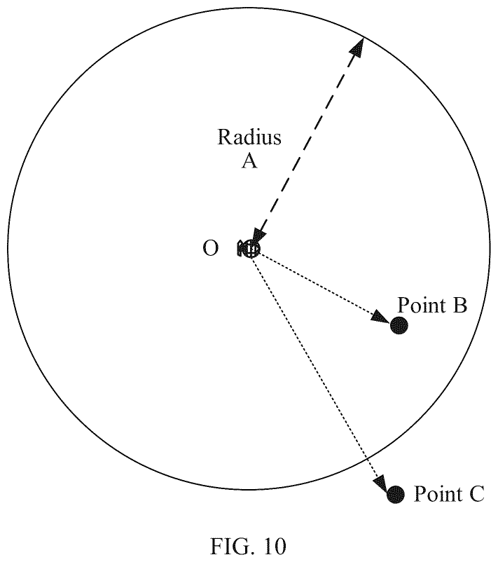

In an example, FIG. 10 is a schematic diagram of determining whether a position of a virtual object is within an action range according to an exemplary embodiment of this application. An action center of an action range of a virtual fluid substance is a point O, and an action radius is a radius A. A position of a first virtual object is a point B, and a position of a second virtual object is a point C. A distance OB is less than the radius A, and a distance OC is greater than the radius A. In other words, the first virtual object is within the action range of the virtual fluid substance, and the second virtual object is not within the action range of the virtual fluid substance.

In this embodiment, it is determined, by determining a straight-line distance between the position of the virtual object and the action center of the virtual fluid substance and comparing the straight-line distance with the action distance, whether the position of the virtual object is within the action range of the virtual fluid substance. In this manner, an effect of the virtual obstacle existing between the position of the virtual object and the action center may be ignored, and a circumstance in the related art is avoided in which a ray emitted from the action center to the position of the virtual object cannot reach the virtual object as a result of existence of the virtual obstacle, and therefore a highly realistic effect can be provided.

In some embodiments, after the virtual object located in the action range of the virtual fluid substance is determined, it continues to be determined whether to trigger the virtual object to obtain the buff of the virtual fluid substance.

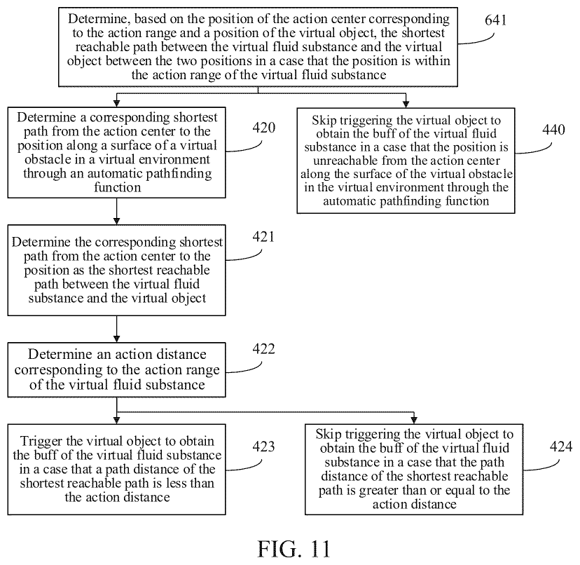

FIG. 11 is a flowchart of a method for controlling a virtual throwable according to an exemplary embodiment of this application. Operation 640 may be implemented as the following operation.

Operation 641: Determine, based on a position of the action center corresponding to the action range and the position of the virtual object, a shortest reachable path between the virtual fluid substance and the virtual object between the two positions when the position is within the action range of the virtual fluid substance.

In some embodiments, a preset starting point within the action range refers to the action center of the action range of the virtual fluid substance. Exemplarily, the action center is a position of a thrown virtual throwable.

Exemplarily, when the position of the virtual object is within the action range of the virtual fluid substance, based on the position of the action center corresponding to the action range and the position of the virtual object, the shortest reachable path between the virtual fluid substance and the virtual object is determined between the two positions.

In some embodiments, operation 641 may be implemented as the following operations.

Operation 420: Determine a corresponding shortest path from the action center to the position along the surface of the virtual obstacle through an automatic pathfinding function.

Exemplarily, the corresponding shortest path from the action center to the position of the virtual object along the surface of the virtual obstacle in the virtual environment includes a plurality of broken lines connected end to end.

In some embodiments, the automatic pathfinding function may be implemented based on at least one of breadth-first search and depth-first search.

Operation 421: Determine the corresponding shortest path from the action center to the position as the shortest reachable path between the virtual fluid substance and the virtual object.

Exemplarily, the corresponding shortest path from the action center to the position of the virtual object is determined as the shortest reachable path between the virtual fluid substance and the virtual object.

For example, a maze exists in the virtual environment. The maze includes a low wall, and the position of the virtual object is a point inside the maze. If the virtual throwable is thrown at an entrance of the maze to release the virtual fluid substance, the shortest reachable path from the action center of the virtual fluid substance to the position is a path along which the virtual fluid substance diffuses over the low wall of the maze to the position of the virtual object.

In this embodiment, the shortest reachable path from the action center to the position of the virtual object may be quickly determined through the automatic pathfinding function provided by a game App without using another calculation method, so as to reduce memory usage of a computer device, and improve processing efficiency.

In some embodiments, operation 660 may be implemented as the following operations.

Operation 422: Determine an action distance corresponding to the action range of the virtual fluid substance.

Exemplarily, the action distance corresponding to the action range of the virtual fluid substance refers to a maximum diffusion distance of the virtual fluid substance, which is also an action radius.

Operation 423: Trigger the virtual object to obtain a buff of the virtual fluid substance when a path distance of the shortest reachable path is less than the action distance.

Exemplarily, an example in which the buff is a negative buff is used. When the path distance of the shortest reachable path is less than the action distance, a reduction in a health point, a skill point, and an attribute point of the virtual object is triggered, or the virtual object is triggered to expose at least one of the positions.

At least one of a degree of decrease in the health point, the skill point, and the attribute point or a degree of exposure of the position is negatively correlated with a movement speed of the virtual object within the action range. In other words, a higher movement speed indicates a smaller degree of decrease or a smaller degree of exposure. Alternatively, at least one of the degree of decrease in the health point, the skill point, and the attribute point or the degree of exposure of the position is positively correlated with a duration for which the virtual object stays in the action range. In other words, a longer stay duration indicates a larger degree of decrease or a larger degree of exposure. In some embodiments, the negative buff further includes a persistent cough.

In some embodiments, at least one of the degree of decrease in the health point, the skill point, and the attribute point or the degree of exposure of the position is further related to a virtual prop used by the virtual object in the action range. For example, the computer device uses a virtual protective prop in response to the virtual object, for example, a virtual protective mask, to reduce the degree of decrease in at least one of the health point, the skill point, and the attribute point described above.

Exemplarily, an example in which the buff is a positive buff is used. When the path distance of the shortest reachable path is less than the action distance, an increase in the health point, the skill point, and the attribute point of the virtual object is triggered, or the virtual object is triggered to hide at least one of the positions.

At least one of a degree of increase in the health point, the skill point, and the attribute point or a degree of hiding of the position is positively correlated with the movement speed of the virtual object within the action range. To be specific, a slower movement speed indicates a larger degree of increase or a larger degree of hiding. Alternatively, at least one of the degree of increase in the health point, the skill point, and the attribute point or the degree of exposure of the position is positively correlated with the duration for which the virtual object stays in the action range. To be specific, a longer stay duration indicates a larger degree of increase or a larger degree of hiding.

In some embodiments, a type of the buff of the virtual fluid substance obtained by triggering the virtual object may further depend on at least one of a camp where the virtual object is located and the type of the virtual object. For example, a virtual throwable released by an allied virtual object causes the allied virtual object to obtain the positive buff and causes an enemy virtual object to obtain the negative buff. For example, when the type of the virtual object is a type mutually restrained with the virtual throwable, the virtual object obtains the negative buff. Otherwise, the virtual object obtains the positive buff.

In this embodiment, when the path distance of the shortest reachable path is less than the action distance, the virtual object is triggered to obtain a buff corresponding to the virtual fluid substance. To be specific, the triggering of the buff fully takes into account the impact of the virtual obstacle in the virtual environment, which is highly consistent with the reality logic and has a highly realistic effect.

In some embodiments, still referring to FIG. 11, the method may further include the following operations.

Operation 424: Skip triggering the virtual object to obtain a buff of the virtual fluid substance when a path distance of the shortest reachable path is greater than or equal to the action distance.

Exemplarily, when the path distance of the shortest reachable path is greater than or equal to the action distance, even if the virtual object is within the action range, the virtual object is not triggered to obtain the buff of the virtual fluid substance.

Operation 440: Skip triggering the virtual object to obtain the buff of the virtual fluid substance when the position is unreachable from the action center along the surface of the virtual obstacle in the virtual environment through the automatic pathfinding function.

Exemplarily, when the position is unreachable from the action center along the surface of the virtual obstacle in the virtual environment through the automatic pathfinding function, namely, the virtual fluid substance cannot diffuse to the position of the virtual object and no reachable path exists, the virtual object is not triggered to obtain the buff of the virtual fluid substance.

In some embodiments, the case that the position is unreachable from the action center along the surface of the virtual obstacle in the virtual environment through the automatic pathfinding function includes that the position of the virtual object is in a four-sided enclosed cover. In other words, when at least one side of the cover in the virtual environment is non-enclosed, the shortest reachable path may be determined.

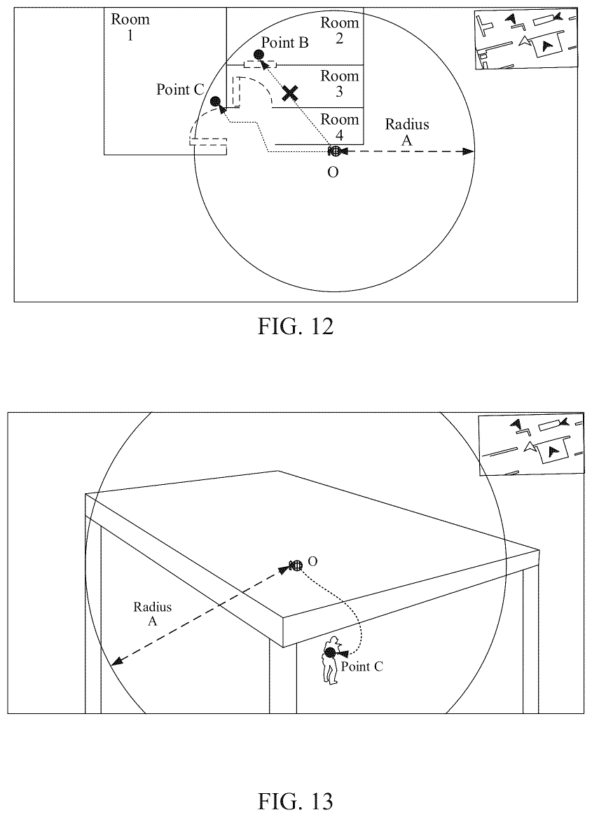

Referring to FIG. 12, in an example, an example in which the buff is the negative buff is used. FIG. 12 is a schematic diagram of determining a shortest reachable path between a position of a virtual object and an action center according to an exemplary embodiment of this application. FIG. 12 includes a room 1 to a room 4. Each room is provided with a movable door. When the movable door of each room is in an open state, 4 rooms may be interconnected. An action center of an action range of a virtual fluid substance is a point O, and an action radius is a radius A. A position of a first virtual object is a point B in a room 2, and a position of a second virtual object is a point C in the room 1. The first virtual object and the second virtual object are both in an action range of a virtual fluid substance. The room 4 is a non-enclosed cover. Through an automatic pathfinding function, a shortest reachable path between the second virtual object and the action center O is a broken line passing through the room 4 and the room 1. The shortest reachable path is greater than the radius A, and the second virtual object does not obtain a negative buff. The first virtual object is in the room 2 and closes the movable door of the room 2, so that the room 2 becomes a four-sided enclosed cover. In this way, the shortest reachable path between the action center and the first virtual object does not exist, and the first virtual object has no negative buff.

Referring to FIG. 13, in an example, an example in which the buff is the negative buff is used. FIG. 13 is a schematic diagram of determining a shortest reachable path between a position of a virtual object and an action center according to an exemplary embodiment of this application. An action center of an action range of a virtual fluid substance is a point O located on a table, and an action radius is a radius A. A position of a third virtual object is a point C under the table. Through an automatic pathfinding function, the shortest reachable path between the third virtual object and the action center O is a broken line crossing the tabletop to reach the point C. The shortest reachable path is less than the radius A, and the third virtual object obtains the negative buff.

In this embodiment, when no reachable path exists between the action center and the position of the virtual object or the path distance of the shortest reachable path is less than the action distance, the virtual object is not triggered to obtain the buff of the virtual fluid substance. To be specific, the triggering of the buff in this embodiment fully takes into account the impact of the virtual obstacle in the virtual environment. Therefore, high consistency with the realistic logic and a highly realistic effect are achieved.

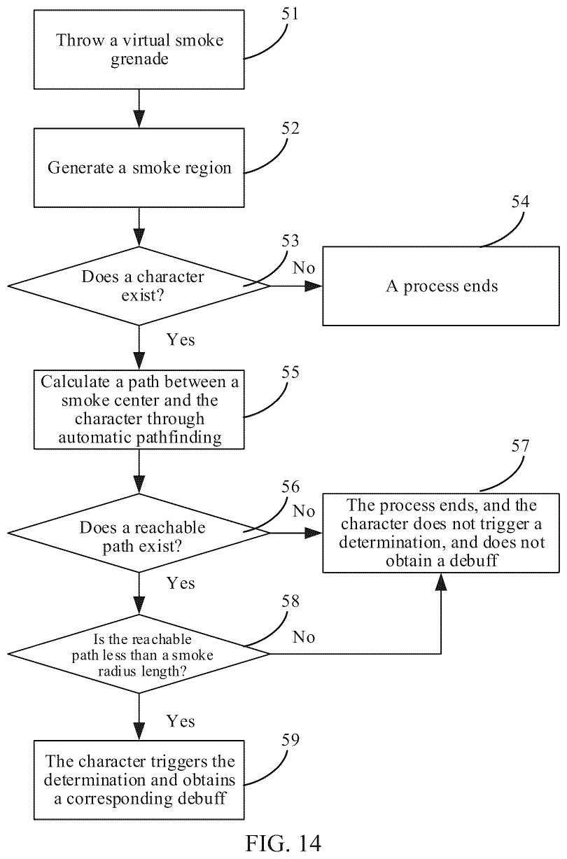

Based on the above, an example in which the virtual throwable object is a virtual smoke grenade, the virtual fluid substance is virtual smoke, the virtual object is a character in a game, and the obtained buff is the negative buff is used. FIG. 14 is a flowchart of a method for controlling a virtual throwable object. Operations of the method for controlling a virtual throwable object provided in this application are as follows.

Operation 51: A computer device responds to throwing of a virtual smoke grenade.

Operation 52: The computer device generates a smoke region corresponding to virtual smoke. In this embodiment, the virtual smoke diffuses along a surface of a virtual obstacle, the smoke region is a diffusion range, and the diffusion range is an action range.

Operation 53: The computer device determines whether a character exists in the smoke region. When the character exists, operation 55 continues to be performed. When no character exists, operation 54 is performed.

Operation 54: A process ends.

Operation 55: The computer device calculates a path between a smoke center and the character through automatic pathfinding.

Operation 56: The computer device determines whether a reachable path exists. When the reachable path exists, operation 58 continues to be performed. When no reachable path exists, operation 57 is performed.

Operation 57: The process ends, and the character does not trigger a determination, and does not obtain a negative buff.

Operation 58: The computer device determines whether a path distance of the shortest reachable path is less than a smoke radius length, and when the path distance of the shortest reachable path is less than the smoke radius length, operation 59 continues to be performed, and when the path distance of the shortest reachable path is greater than or equal to the smoke radius length, operation 57 is performed.

Operation 59: The character triggers the determination and obtains the negative buff corresponding to the virtual smoke.

In some embodiments, when at least two virtual throwable objects are simultaneously thrown and at least two parts of the virtual fluid substance are generated, the foregoing operations may be performed by using the at least two parts of the virtual fluid substance as a whole. Alternatively, the foregoing operations are performed for each part of the virtual fluid substance to trigger the virtual object to obtain a strongest buff in the at least two parts of the virtual fluid substance.

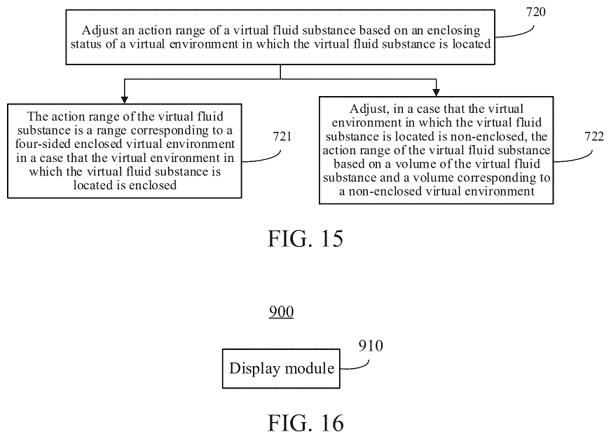

In some embodiments, based on a fluid property of the virtual fluid substance, the action range of the virtual fluid substance varies with the overall enclosing status of the virtual environment. FIG. 15 is a flowchart showing a method for controlling a virtual throwable object according to an exemplary embodiment of this application. The method may further include the following operations.

Operation 720: Adjust an action range of a virtual fluid substance based on an enclosing status of the virtual environment in which the virtual fluid substance is located.

The enclosing status of the virtual environment is determined based on a virtual obstacle in the virtual environment. The enclosing status includes one of enclosed and non-enclosed.

Exemplarily, when the virtual obstacle forms a four-sided enclosed cover, the virtual environment is enclosed. For example, a room has four fixed walls, and one fixed wall is provided with a movable door. The movable door is closed to form the four-sided enclosed cover. When the virtual obstacle forms a cover with at least one non-enclosed side, the virtual environment is non-enclosed. For example, a room has four fixed walls, and one fixed wall is provided with a movable door. The movable door is opened to form a non-enclosed cover.

Operation 721: Determine the action range of the virtual fluid substance as a range corresponding to an enclosed virtual environment when the virtual environment in which the virtual fluid substance is located is enclosed.

Exemplarily, the action range of the virtual fluid substance is the range corresponding to the enclosed virtual environment when the virtual environment in which the virtual fluid substance is located is enclosed.

For example, if the virtual throwable explodes in an enclosed room, the action range of the virtual fluid substance is a range corresponding to the room.

Operation 722: Adjust the action range of the virtual fluid substance based on a volume of the virtual fluid substance and a volume corresponding to a non-enclosed virtual environment when the virtual environment where the virtual fluid substance is located is non-enclosed.

In some embodiments, when the virtual environment in which the virtual fluid substance is located is non-enclosed and a volume of the virtual fluid substance is less than a volume corresponding to the non-enclosed virtual environment, a range corresponding to the virtual fluid substance is used as the action range of the virtual fluid substance. In this case, the action range is the range corresponding to the virtual fluid substance.

In some embodiments, when the virtual environment in which the virtual fluid substance is located is non-enclosed and the volume of the virtual fluid substance is equal to the volume corresponding to the non-enclosed virtual environment, the range corresponding to the virtual fluid substance or the range corresponding to the non-enclosed virtual environment is used as the action range of the virtual fluid substance. In this case, the action range is the range corresponding to the virtual fluid substance or the range corresponding to the non-enclosed virtual environment.

In some embodiments, when the virtual environment in which the virtual fluid substance is located is non-enclosed and the volume of the virtual fluid substance is greater than the volume corresponding to the non-enclosed virtual environment, a sum of the range corresponding to the non-enclosed virtual environment and a range corresponding to a volume difference is used as the action range of the virtual fluid substance. In this case, the action range is the range corresponding to the non-enclosed virtual environment and a range of the diffusion of the virtual fluid substance outside the non-enclosed virtual environment.

A range corresponding to the volume difference refers to a range corresponding to a difference between the volume of the virtual fluid substance and the volume corresponding to the non-enclosed virtual environment.

For example, if a virtual throwable explodes in a non-enclosed room, a volume of a virtual fluid substance corresponding to the virtual throwable is 10, and a volume of the non-enclosed room is 7, the virtual fluid substance may diffuse into a corridor outside the room, and a diffusion volume is 10−7=3. In this case, the action range is a range corresponding to the room and at least part of the corridor.

In this embodiment, the action range of the virtual fluid substance may further be adjusted based on an actual situation of the virtual environment. Considering the distribution of the virtual obstacle in the virtual environment, and causing the action range to be highly consistent with actual cognition, it may be further more accurately determined whether the virtual object is within the action range.

FIG. 16 is a structural block diagram of an apparatus for controlling a virtual throwable according to an exemplary embodiment of this application. The apparatus 900 includes:
a display module 910, configured to perform operation 402 in the embodiment of FIG. 4 described above.

The display module 910 is configured to perform operation 404 in the embodiment of FIG. 4 described above.

The display module 910 is configured to perform operation 406 in the embodiment of FIG. 4 described above.

In some embodiments, the display module 910 is configured to perform operation 506 in the embodiment of FIG. 5 described above.

In some embodiments, the display module 910 is configured to perform operation 507 and operation 508 in the embodiment of FIG. 5 described above.

In some embodiments, the display module 910 is further configured to perform operation 610 in the embodiment of FIG. 7 described above.

In some embodiments, the apparatus further includes a triggering module. The triggering module is configured to perform operation 611 in the embodiment of FIG. 7 described above.

In some embodiments, the apparatus further includes an obtaining module. The obtaining module is configured to perform operation 620 in the embodiment of FIG. 8 described above.

In some embodiments, the apparatus further includes a determination module. The determination module is configured to perform operation 640 in the embodiment of FIG. 8 described above.

In some embodiments, the triggering module is configured to perform operation 660 in the embodiment of FIG. 8 described above.

In some embodiments, the determination module is configured to perform operation 641 in the embodiment of FIG. 11 described above.

In some embodiments, the determination module is configured to perform operation 420 and operation 421 in the embodiment of FIG. 11 described above.

In some embodiments, the determination module is configured to perform operation 422 in the embodiment of FIG. 11 described above.

In some embodiments, the triggering module is configured to perform operation 423 in the embodiment of FIG. 11 described above.

In some embodiments, the triggering module is configured to perform operation 423 in the embodiment of FIG. 11 described above.

In some embodiments, the triggering module is further configured to perform operation 424 in the embodiment of FIG. 11 described above.

In some embodiments, the triggering module is further configured to perform operation 440 in the embodiment of FIG. 11 described above.

In some embodiments, the determination module is further configured to perform operation 460 and operation 461 in the embodiment of FIG. 9 described above.

In some embodiments, the apparatus further includes an adjustment module. The adjustment module is configured to perform operation 720 in the embodiment of FIG. 15 described above.

In some embodiments, the adjustment module is configured to perform operation 721 and operation 722 in the embodiment of FIG. 15 described above.

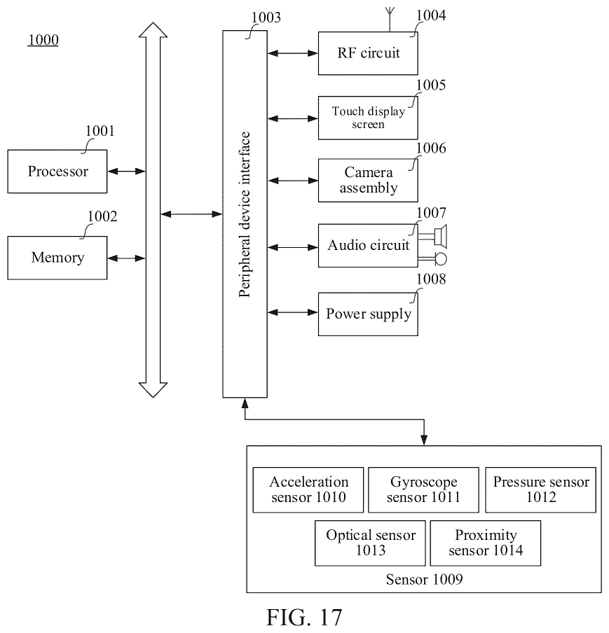

FIG. 17 is a schematic structural diagram of a computer device according to an exemplary embodiment of this application.

The computer device 1000 may be a portable mobile terminal, for example, a smartphone, a tablet computer, a moving picture experts group audio layer III (MP3) player, or a moving picture experts group audio layer IV (MP4) player. The computer device 1000 may further be referred to as another name such as a user equipment or a portable terminal.

Generally, the computer device 1000 includes a processor 1001 and a memory 1002.

The processor 1001 may include one or more processing cores, for example, a 4-core processor or an 8-core processor. The processor 1001 may be implemented in at least one hardware form of digital signal processing (DSP), a field programmable gate array (FPGA), and a programmable logic array (PLA). The processor 1001 may also include a main processor and a coprocessor. The main processor is a processor configured to process data in an awake state, and is also referred to as a central processing unit (CPU). The coprocessor is a low-power processor configured to process data in a standby state. In some embodiments, the processor 1001 may be integrated with a graphics processing unit (GPU). The GPU is configured to render and draw content that needs to be displayed on a display screen. In some embodiments, the processor 1001 may further include an AI processor. The AI processor is configured to process computing operations related to machine learning.

The memory 1002 may include one or more non-transitory computer-readable storage media. The computer-readable storage medium may be tangible and non-transient. The memory 1002 may further include a high-speed random access memory and a nonvolatile memory, for example, one or more disk storage devices or flash storage devices. In some embodiments, a non-transitory computer-readable storage medium in the memory 1002 is configured to store at least one instruction, the at least one instruction being configured to be executed by the processor 1001 to implement the method for controlling a virtual throwable provided in the embodiments of this application.

In some embodiments, the computer device 1000 may further include a peripheral device interface 1003 and at least one peripheral device. Specifically, the peripheral device includes at least one of a radio frequency (RF) circuit 1004, a touch display screen 1005, a camera 1006, an audio circuit 1007, and a power supply 1008.

The peripheral device interface 1003 may be configured to connect the at least one peripheral device related to input/output (I/O) to the processor 1001 and the memory 1002. In some embodiments, the processor 1001, the memory 1002, and the peripheral device interface 1003 are integrated on the same chip or circuit board. In some other embodiments, any or both of the processor 1001, the memory 1002, and the peripheral device interface 1003 may be implemented on an independent chip or circuit board, which is not limited in this embodiment.

The RF circuit 1004 is configured to receive and transmit an RF signal, which is also referred to as an electromagnetic signal. The RF circuit 1004 communicates with a communication network and another communication device through the electromagnetic signal. The RF circuit 1004 converts an electric signal into an electromagnetic signal for transmission, or converts a received electromagnetic signal into an electric signal. In some embodiments, the RF circuit 1004 includes an antenna system, an RF transceiver, one or more amplifiers, a tuner, an oscillator, a digital signal processor, a codec chip set, a subscriber identity module card, and the like. The RF circuit 1004 may communicate with another terminal through at least one wireless communication protocol. The wireless communication protocol includes but is not limited to the World Wide Web, a metropolitan area network, Intranet, various generations of mobile communication networks (2G, 3G, 4G, and 5G), a wireless local area network, and/or a wireless fidelity (Wi-Fi) network. In some embodiments, the RF circuit 1004 may further include a near field communication (NFC)-related circuit, which is not limited in this application.

The touch display screen 1005 is configured to display a UI. The UI may include a graph, texts, an icon, a video, and any combination thereof. The touch display screen 1005 further has a capability of collecting a touch signal on or above a surface of the touch display screen 1005. The touch signal may be inputted to the processor 1001 as a control signal for processing. The touch display screen 1005 is configured to provide a virtual button and/or a virtual keyboard, which are/is also referred to as a soft button and/or a soft keyboard. In some embodiments, one touch display screen 1005 may be arranged on a front panel of the computer device 1000. In some other embodiments, at least two touch display screens 1005 may be respectively arranged on different surfaces of the computer device 1000 or may be folded. In some embodiments, the touch display screen 1005 may be a flexible display screen arranged on a curved surface or a folded surface of the computer device 1000. The touch display screen 1005 may further be arranged as a non-rectangular irregular figure, i.e., a special-shaped screen. The touch display screen 1005 may be manufactured by using a liquid crystal display (LCD), an organic light-emitting diode (OLED), or the like.

The camera assembly 1006 is configured to collect an image or a video. In some embodiments, the camera assembly 1006 includes a front camera and a rear camera. Generally, the front camera is configured to enable a video call or a selfie and the rear camera is configured to shoot a photo or a video. In some embodiments, at least two rear cameras are arranged, which are respectively any of a main camera, a depth-of-field camera, and a wide-angle camera, to achieve background blurring through fusion of the main camera and the depth-of-field camera, and panoramic photographing and VR photographing through fusion of the main camera and the wide-angle camera. In some embodiments, the camera assembly 1006 may further include a flash. The flashlight may be a single-color-temperature flash, or may be a dual-color-temperature flash. The dual-color-temperature flash is a combination of a warm flash and a cold flash, which may be configured for light compensation at different color temperatures.

The audio circuit 1007 is configured to provide an audio interface between the user and the computer device 1000. The audio circuit 1007 may include a microphone and a speaker. The microphone is configured to collect sound waves of a user and an environment, and convert the sound waves into electrical signals and input the electrical signals to the processor 1001 for processing, or input the electrical signals to the RF circuit 1004 to implement voice communication. For the purpose of stereo collection or noise reduction, a plurality of microphones may be respectively arranged at different parts of the computer device 1000. The microphone may be further an array microphone or an omnidirectional acquisition microphone. The speaker is configured to convert the electrical signal from the processor 1001 or the RF circuit 1004 into sound waves. The speaker may be a conventional film speaker, or may be a piezoelectric ceramic speaker. When the speaker is the piezoelectric ceramic speaker, the speaker not only may convert an electric signal into the sound wave audible to human, but also may convert the electric signal into the sound wave inaudible to the human for purposes such as ranging. In some embodiments, the audio circuit 1007 may further include a headphone jack.

The power supply 1008 is configured to supply power to assemblies in the computer device 1000. The power supply 1008 may be an alternating current battery, a direct current battery, a disposable battery, or a rechargeable battery. When the power supply 1008 includes a rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some embodiments, the computer device 1000 further includes one or more sensors 1009. The one or more sensors 1009 include but are not limited to an acceleration sensor 1010, a gyroscope sensor 1011, a pressure sensor 1012, an optical sensor 1013, and a proximity sensor 1014.

A person skilled in the art may understand that the structure shown in FIG. 17 does not constitute a limitation on the computer device 1000, and the computer device may include more or fewer components than those shown in the figure, or some merged components, or different component arrangements.

In an exemplary embodiment, a chip is further provided, including a programmable logic circuit and/or program instructions, the chip, when run on a computer device, being configured to implement the method for controlling a virtual throwable provided in the foregoing method embodiments.

This application provides a non-transitory computer-readable storage medium, the computer-readable storage medium having a computer program stored therein, the computer program being loaded and executed by a processor to implement the method for controlling a virtual throwable provided in the foregoing method embodiments.

This application provides a computer program product or a computer program, the computer program product including computer instructions, the computer instructions being stored in a computer-readable storage medium, a processor obtaining the computer instructions from the computer-readable storage medium, causing the processor to implement the method for controlling a virtual throwable provided in the foregoing method embodiments.

What is claimed is:

1. A method for controlling a virtual throwable performed by a computer device, and comprising:
displaying a picture of a virtual environment;
displaying a virtual fluid substance released by the virtual throwable in response to a thrown virtual throwable exploding in the virtual environment; and
in response to the virtual fluid substance encountering a virtual obstacle during diffusion in the virtual environment, changing a direction of the diffusion of the virtual fluid substance based on an interaction of the virtual fluid substance with the virtual obstacle.

2. The method according to claim 1, wherein the changing a direction of the diffusion of the virtual fluid substance based on an interaction of the virtual fluid substance with the virtual obstacle comprises:
displaying the virtual fluid substance diffusing along a surface of the virtual obstacle in response to the virtual fluid substance encountering the virtual obstacle during the diffusion.

3. The method according to claim 2, wherein the displaying the virtual fluid substance diffusing along a surface of the virtual obstacle in response to the virtual fluid substance encountering the virtual obstacle during the diffusion comprises:
displaying the virtual fluid substance diffusing in a first direction with an explosion point of the virtual throwable as a center; and
in response to the virtual fluid substance diffusing in the first direction encountering the virtual obstacle during the diffusion, displaying the virtual fluid substance diffusing in a second direction along the surface of the virtual obstacle.

4. The method according to claim 1, further comprising:
responding to a virtual object entering an action range of the virtual fluid substance, the action range of the virtual fluid substance being less than or equal to a diffusion range of the virtual fluid substance; and
triggering the virtual object to obtain a buff of the virtual fluid substance when a shortest reachable path between the virtual fluid substance and the virtual object meets a triggering condition,
the shortest reachable path being configured to characterize a shortest path along which the virtual fluid substance diffuses along the surface of the virtual obstacle to a position of the virtual object.

5. The method according to claim 4, further comprising:
obtaining the position of the virtual object;
determining the shortest reachable path between the virtual fluid substance and the virtual object when the position is within the action range of the virtual fluid substance; and
triggering the virtual object to obtain the buff of the virtual fluid substance when the shortest reachable path between the virtual fluid substance and the virtual object meets the triggering condition.

6. The method according to claim 4, wherein the triggering the virtual object to obtain a buff of the virtual fluid substance when a shortest reachable path between the virtual fluid substance and the virtual object meets a triggering condition comprises:
determining an action distance corresponding to the action range of the virtual fluid substance; and triggering the virtual object to obtain the buff of the virtual fluid substance when a path distance of the shortest reachable path is less than the action distance.

7. The method according to claim 4, further comprising:
determining, based on the position of the virtual object and the position of the action center of the virtual fluid substance, a straight-line distance between the position and the action center between the two positions; and
determining that the position is within the action range of the virtual fluid substance when the straight-line distance is less than the action distance.

8. The method according to claim 4, further comprising:
adjusting the action range of the virtual fluid substance based on an enclosing status of the virtual environment in which the virtual fluid substance is located.

9. A computer device, comprising a processor and a memory, the memory having a computer program stored therein, the computer program, when loaded and executed by the processor, causing the computer device to implement a method for controlling a virtual throwable including:
displaying a picture of a virtual environment;
displaying a virtual fluid substance released by the virtual throwable in response to a thrown virtual throwable exploding in the virtual environment; and
in response to the virtual fluid substance encountering a virtual obstacle during diffusion in the virtual environment, changing a direction of the diffusion of the virtual fluid substance based on an interaction of the virtual fluid substance with the virtual obstacle.

10. The computer device according to claim 9, wherein the changing a direction of the diffusion of the virtual fluid substance based on an interaction of the virtual fluid substance with the virtual obstacle comprises:
displaying the virtual fluid substance diffusing along a surface of the virtual obstacle in response to the virtual fluid substance encountering the virtual obstacle during the diffusion.

11. The computer device according to claim 10, wherein the displaying the virtual fluid substance diffusing along a surface of the virtual obstacle in response to the virtual fluid substance encountering the virtual obstacle during the diffusion comprises:
displaying the virtual fluid substance diffusing in a first direction with an explosion point of the virtual throwable as a center; and
in response to the virtual fluid substance diffusing in the first direction encountering the virtual obstacle during the diffusion, displaying the virtual fluid substance diffusing in a second direction along the surface of the virtual obstacle.

12. The computer device according to claim 9, wherein the method further comprises:
responding to a virtual object entering an action range of the virtual fluid substance, the action range of the virtual fluid substance being less than or equal to a diffusion range of the virtual fluid substance; and
triggering the virtual object to obtain a buff of the virtual fluid substance when a shortest reachable path between the virtual fluid substance and the virtual object meets a triggering condition,
the shortest reachable path being configured to characterize a shortest path along which the virtual fluid substance diffuses along the surface of the virtual obstacle to a position of the virtual object.

13. The computer device according to claim 12, wherein the method further comprises:
obtaining the position of the virtual object;
determining the shortest reachable path between the virtual fluid substance and the virtual object when the position is within the action range of the virtual fluid substance; and
triggering the virtual object to obtain the buff of the virtual fluid substance when the shortest reachable path between the virtual fluid substance and the virtual object meets the triggering condition.

14. The computer device according to claim 12, wherein the triggering the virtual object to obtain a buff of the virtual fluid substance when a shortest reachable path between the virtual fluid substance and the virtual object meets a triggering condition comprises:
determining an action distance corresponding to the action range of the virtual fluid substance; and triggering the virtual object to obtain the buff of the virtual fluid substance when a path distance of the shortest reachable path is less than the action distance.

15. The computer device according to claim 12, wherein the method further comprises:
determining, based on the position of the virtual object and the position of the action center of the virtual fluid substance, a straight-line distance between the position and the action center between the two positions; and
determining that the position is within the action range of the virtual fluid substance when the straight-line distance is less than the action distance.

16. The computer device according to claim 12, wherein the method further comprises:
adjusting the action range of the virtual fluid substance based on an enclosing status of the virtual environment in which the virtual fluid substance is located.

17. A non-transitory computer-readable storage medium, having a computer program stored therein, the computer program, when loaded and executed by a processor of a computer device, causing the computer device to implement a method for controlling a virtual throwable including:
displaying a picture of a virtual environment;
displaying a virtual fluid substance released by the virtual throwable in response to a thrown virtual throwable exploding in the virtual environment; and
in response to the virtual fluid substance encountering a virtual obstacle during diffusion in the virtual environment, changing a direction of the diffusion of the virtual fluid substance based on an interaction of the virtual fluid substance with the virtual obstacle.

18. The non-transitory computer-readable storage medium according to claim 17, wherein the changing a direction of the diffusion of the virtual fluid substance based on an interaction of the virtual fluid substance with the virtual obstacle comprises:
displaying the virtual fluid substance diffusing along a surface of the virtual obstacle in response to the virtual fluid substance encountering the virtual obstacle during the diffusion.

19. The non-transitory computer-readable storage medium according to claim 18, wherein the displaying the virtual fluid substance diffusing along a surface of the virtual obstacle in response to the virtual fluid substance encountering the virtual obstacle during the diffusion comprises:
displaying the virtual fluid substance diffusing in a first direction with an explosion point of the virtual throwable as a center; and
in response to the virtual fluid substance diffusing in the first direction encountering the virtual obstacle during the diffusion, displaying the virtual fluid substance diffusing in a second direction along the surface of the virtual obstacle.

20. The non-transitory computer-readable storage medium according to claim 17, wherein the method further comprises:
responding to a virtual object entering an action range of the virtual fluid substance, the action range of the virtual fluid substance being less than or equal to a diffusion range of the virtual fluid substance; and
triggering the virtual object to obtain a buff of the virtual fluid substance when a shortest reachable path between the virtual fluid substance and the virtual object meets a triggering condition,
the shortest reachable path being configured to characterize a shortest path along which the virtual fluid substance diffuses along the surface of the virtual obstacle to a position of the virtual object.
